(19) United States
(12) Patent Application Publication
(10) Pub. No.: US 2016/0273423 A1
(43) Pub. Date: Sep. 22, 2016

(54) CIRCUMFERENTIAL BREATHER VENT

(71) Applicant: K&N Engineering, Inc., Riverside, CA (US)

(72) Inventors: Steve E. Williams, Cherry Valley, CA (US); Jere James Wall, Helendale, CA (US)

(73) Assignee: K&N Engineering, Inc., Riverside, CA (US)

(21) Appl. No.: 15/075,124

(22) Filed: Mar. 19, 2016

Related U.S. Application Data
(63) Continuation of application No. 62/136,346, filed on Mar. 20, 2015.

(51) Int. Cl. F01M 13/00; F02M 25/06

(52) U.S. Cl. CPC F01M 13/0011; F01M 13/0033; F02M 25/06

(57) ABSTRACT

An apparatus and method are provided for a breather vent configured to be mounted onto a crankcase breather inlet of an internal combustion engine, such that particulate matter and contaminates are removed from an airstream entering into an interior of the crankcase. The breather vent comprises a base including a fitting receiver configured to retain a breather end of an adaptive fitting. An inlet end of the adaptive fitting is configured to be coupled with the crankcase breather inlet of the engine. A filter medium is fastened to the base and configured to remove the particulate matter and contaminates from the incoming airstream. The filter medium circumferentially surrounds the interior cavity and forms an exterior perimeter of a portion of the cavity. A cap is affixed to the filter medium, such that the filter medium is retained between the base and the cap.

### PRIORITY

This application claims the benefit of and priority to U.S. Provisional Application, entitled “Circumferential Breather Vent” filed on Mar. 20, 2015 and having application Ser. No. 62/136,346.

### FIELD

The field of the present disclosure generally relates to filtration devices. More particularly, the field of the present disclosure relates to an apparatus and a method for a breather vent configured to be mounted onto a crankcase breather inlet of an internal combustion engine, such that particulate matter and contaminates are removed from an airstream entering into an interior of the crankcase.

### BACKGROUND

A crankcase ventilation system generally serves as a controlled one-way passage for gases to be drawn out of a crankcase of an internal combustion engine. During internal combustion, a small portion of air-fuel mixture being combusted generally leaks from combustion chambers of the engine and enters into the crankcase. The leaked portion of air-fuel mixture generally is referred to as “blow-by” gases. A buildup of blow-by gases within the crankcase is continual during operation of the engine. If left unchecked, the blow-by gases increase in pressure within the crankcase, thereby causing oil leaks and other damage to the engine.

An early attempt to eliminate internal crankcase pressure was a road draft tube, typically comprising a pipe starting at a high location of the crankcase, such as a side of the engine or a valve cover on an overhead valve engine, and extending to an open end facing downward. During engine operation, when the vehicle is moving, airflow across the open end of the draft tube creates a draft that draws blow-by gases from the crankcase and vents the gases to the atmosphere. An air inlet to the crankcase, called a “breather,” allows fresh air to enter the crankcase so as to clear out the blow-by gases.

A drawback to the road draft tube is that it does not function when the vehicle is not moving, or the vehicle moves too slowly to create a draft within the crankcase. Thus, slow-moving vehicles, such as postal vehicles and other delivery vehicles, tend to suffer from a rapid buildup of engine sludge due to poor crankcase ventilation. Moreover, vehicles that don't generate a draft on the tube regardless of their speed, such as boats, also suffer from sludge build up. Another drawback to the road draft tube is that the blow-by gases, comprising chiefly unburned hydrocarbons, are discharged directly into the atmosphere, thereby contributing to air pollution.

Today's positive crankcase ventilation (PCV) systems generally eliminate the problems associated with internal crankcase pressure and air pollution due to blow-by gases. A modern PCV system typically comprises a breather tube and a PCV valve. The breather tube connects the crankcase to a source of fresh air, typically clean air from the air filter body, whereby the fresh air is drawn through the breather tube into the engine. The air circulates within the interior of the engine, capturing blow-by gases, including any moisture present. The air is then drawn out of the interior of the engine though a PCV valve and passed to an intake manifold of the engine, such that the blow-by gases are combusted during engine operation.

It will be recognized that not all internal combustion engines use PCV valves. For example, engines that are not subject to emission controls, such as certain off-road engines, dragsters, and other performance vehicles use techniques other than the PCV valve to eliminate internal crankcase pressure. In absence of the PCV valve, there is no need for a breather tube, and thus it is desirable to install a performance crankcase breather vent. Often times, the performance crankcase breather vent resembles a small air filter configured to ensure only clean fresh air is drawn into the crankcase.

A drawback to conventional crankcase breather vents is that it is difficult for a manufacturer to produce performance breather vents for all the various makes and models of vehicles for which the breather vent may be used. For example, one manufacturer produces over 70 different performance breather vents in an attempt to offer a breather vent application to as many different vehicles as possible. Such a large inventory is a burden on many retailers, such as race shops, engine builders, auto parts stores, and jobbers, whom simply choose to not stock a massive inventory of parts. Moreover, consumers find the large number of different performance breather vents to be difficult to purchase online due to the sheer number of part numbers. Many of the part numbers are so similar to one another that many consumers fear accidentally purchasing a wrong breather vent for their vehicle. What is needed, therefore, is a performance crankcase breather vent package whereby a single crankcase breather vent may be installed onto a wide variety of different makes and models of vehicles.

### SUMMARY

An apparatus and method are provided for a breather vent configured to be mounted onto a crankcase breather inlet of an internal combustion engine. The breather vent comprises a base that includes a fitting receiver configured to retain an adaptive fitting which is suitably sized to be received by the crankcase breather inlet. The adaptive fitting provides an opening between the crankcase breather inlet and an interior cavity of the breather vent. A clamp is configured to secure the adaptive fitting within the fitting receiver. A filter medium is fastened to the base and configured to remove particulate matter and other contaminates from an incoming airstream. The filter medium may be formed of any of paper, foam, cotton, spun fiberglass, or other known filter materials, woven or non-woven material, synthetic or natural, or any combination thereof, that is arranged into a surface area for passing the incoming airstream to be cleaned. In some embodiments, a wire support may be incorporated into the filter medium so as to impart additional strength and durability to the breather vent. The filter medium circumferentially surrounds the interior cavity of the breather vent so as to form an exterior perimeter of at least a portion of the interior cavity. A cap is affixed to the filter medium, such that the filter medium is retained between the base and the cap.

In an exemplary embodiment, a breather vent configured to be mounted onto a crankcase breather inlet of an internal combustion engine comprises a base comprising a fitting receiver configured to retain an adaptive fitting which is suitably sized to be received by the crankcase breather inlet and includes an opening into an interior cavity of the breather vent; a clamp configured to secure the adaptive fitting within the fitting receiver; a filter medium fastened to the base and configured to remove particulate matter and other contaminates from an incoming airstream, the filter medium circumferentially surrounding the interior cavity so as to form an exterior perimeter of at least a portion of the cavity; and a cap affixed to the filter medium, such that the filter medium is retained between the base and the cap.

In another exemplary embodiment, the base and the cap are configured such that the incoming airstream is drawn through the filter medium into the interior cavity and then is conducted through the adaptive fitting into the crankcase breather inlet of the engine. In another exemplary embodiment, the filter medium is comprised of paper, foam, cotton, spun fiberglass, or other known filter materials, woven or non-woven material, synthetic or natural, or any combination thereof. In another exemplary embodiment, the filter medium is pleated or otherwise shaped or contoured to increase a surface area for passing the airstream to be cleaned. In another exemplary embodiment, the filter medium comprises a filter oil composition to enhance air cleaning properties of the filter medium.

In another exemplary embodiment, a wire support is incorporated into the filter medium so as to impart additional strength and durability to the breather vent. In another exemplary embodiment, the filter medium is positioned between the wire support and one or more layers of a reinforcing material. In another exemplary embodiment, the wire support comprises wire screens positioned on an outer surface and an inner surface of the filter medium. In another exemplary embodiment, the wire screens are comprised of powder-coated aluminum screen wire that is co-pleated along with the filter medium so as to reinforce the breather vent.

In another exemplary embodiment, the adaptive fitting comprises a breather end and an inlet end, the breather end being configured to be retained by the fitting receiver, and the inlet end being configured to be coupled with the crankcase breather inlet of the engine. In another exemplary embodiment, the adaptive fitting comprises an inlet end having a configuration and a diameter suitable for coupling the breather vent with the crankcase breather inlet of the engine. In another exemplary embodiment, the inlet end comprises a male configuration having an outer diameter suitable to couple the breather vent with the crankcase breather inlet of the engine. In another exemplary embodiment, the inlet end comprises a female configuration having an inner diameter suitable to couple the breather vent with the crankcase breather inlet of the engine.

In an exemplary embodiment, a method for a breather vent to be mounted onto a crankcase breather inlet of an internal combustion engine comprises forming an adaptive fitting comprising an opening and having a breather end and an inlet end, such that the inlet end is suitably sized to be coupled with the crankcase breather inlet of the engine; configuring a fitting receiver within a base to retain the breather end, such that the opening provides fluid communication between the crankcase breather inlet of the engine and an interior cavity of the breather vent; securing the adaptive fitting within the fitting receiver by way of a clamp; fabricating a filter medium to remove particulate matter and other contaminates from an airstream flowing there through; fastening the filter medium to the base, the filter medium being disposed circumferentially around the interior cavity so as to form an exterior perimeter of at least a portion of the interior cavity; and affixing a cap to the filter medium, such that the filter medium is retained between the base and the cap.

In another exemplary embodiment, forming the adaptive fitting comprises configuring the inlet end with a diameter suitable for coupling the breather vent with the crankcase breather inlet of the engine. In another exemplary embodiment, configuring the inlet end comprises forming a male configuration of the inlet end having an outer diameter suitable to be received by the crankcase breather inlet of the engine. In another exemplary embodiment, configuring the inlet end comprises forming a female configuration of the inlet end having an inner diameter suitable to receive the crankcase breather inlet of the engine.

In another exemplary embodiment, fabricating the filter medium comprises forming any of paper, foam, cotton, spun fiberglass, or other known filter materials, woven or non-woven material, synthetic or natural, or any combination thereof, into a surface area for passing an airstream to be cleaned. In another exemplary embodiment, fabricating the filter medium comprises incorporating a wire support into the filter medium so as to impart additional strength and durability to the breather vent. In another exemplary embodiment, incorporating the wire support comprises positioning a first wire screen on an outside surface of the filter medium and positioning a second wire screen on an inner surface of the filter medium.

### BRIEF DESCRIPTION OF THE DRAWINGS

The drawings refer to embodiments of the present disclosure in which:

FIG. 1 illustrates an exemplary embodiment of a crankcase breather vent package comprising a breather vent and a multiplicity of adaptive fittings, according to the present disclosure;

FIG. 2 illustrates an exemplary embodiment of a crankcase breather vent package comprising four adaptive fittings configured to couple a breather vent with crankcase breather inlets of various makes and models of vehicles in accordance the present disclosure;

FIG. 3 illustrates an exemplary embodiment of a crankcase breather vent package comprising a breather vent and four male adaptive fittings configured to couple the breather vent with crankcase breather inlets of various makes and models of vehicles, according to the present disclosure;

FIG. 4 illustrates an exemplary embodiment of a crankcase breather vent package comprising a breather vent bundled with four female adaptive fittings configured to couple the breather vent with crankcase breather inlets of various makes and models of vehicles, according to the present disclosure;

FIG. 5 illustrates an exemplary embodiment of a crankcase breather vent package comprising a breather vent bundled with four male adaptive fittings configured to couple the breather vent with crankcase breather inlets of various makes and models of vehicles in accordance with the present disclosure; and

FIG. 6 illustrates an exemplary embodiment of a crankcase breather vent package comprising a breather vent and four female adaptive fittings configured to couple the breather vent with crankcase breather inlets of various makes and models of vehicles in accordance with the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first vent,” may be made. However, the specific numeric reference should not be interpreted as a literal sequential order but rather interpreted that the “first vent” is different than a “second vent.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and a method for a breather vent configured to be mounted onto a crankcase breather inlet of an internal combustion engine, such that particulate matter and contaminates are removed from an airstream entering into an interior of the crankcase. The breather vent comprises a base including a fitting receiver configured to receive a breather end of an adaptive fitting. A clamp is configured to secure the breather end within the fitting receiver. The adaptive fitting is suitably sized to be received by the crankcase breather inlet and includes an opening into an interior cavity of the breather vent. An inlet end of the adaptive fitting is configured to be coupled with the crankcase breather inlet of the engine. In some embodiments, the inlet end comprises a male configuration having an outer diameter suitable to couple the breather vent with the crankcase breather inlet of the engine. In some embodiments, the inlet end comprises a female configuration having an inner diameter suitable to couple the breather vent with the crankcase breather inlet of the engine. A filter medium is fastened to the base and configured to remove the particulate matter and contaminates from the incoming airstream. The filter medium circumferentially surrounds the interior cavity so as to form an exterior perimeter of at least a portion of the cavity. In some embodiments, the filter medium is positioned between wire screens positioned on an outer surface and an inner surface of the filter medium. A cap is affixed to the filter medium, such that the filter medium is retained between the base and the cap.

Although embodiments of the present disclosure may be described and illustrated herein in terms of a cylindrical breather vent, it should be understood that embodiments of the present disclosure are not limited to the exact shapes illustrated, but rather may include a wide variety of generally cylindrical shapes, generally circular, oval, round, curved, conical, or other closed perimeter shapes, that provide a relatively large surface area in a given volume of the breather vent.

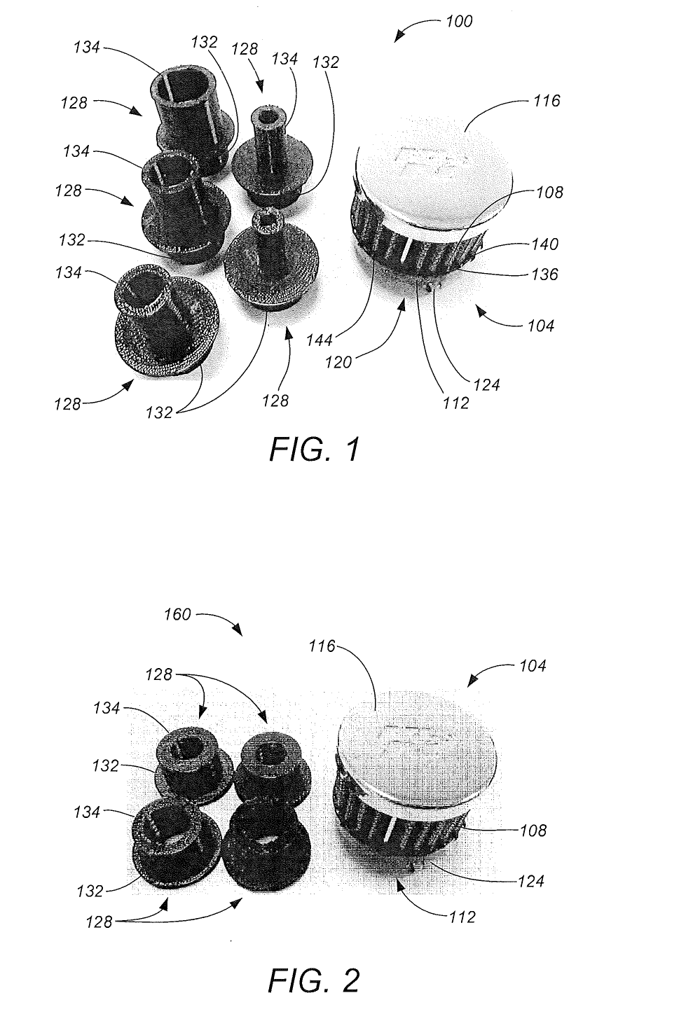

FIG. 1 illustrates an exemplary embodiment of a crankcase breather vent package 100 comprising a breather vent 104, according to the present disclosure. The crankcase breather vent package 100 is configured to be mounted onto a crankcase breather inlet of an internal combustion engine. In the embodiment illustrated in FIG. 1, the breather vent 104 comprises a filter medium 108 retained between a base 112 and a cap 116. The base 112 further comprises a fitting receiver 120, which includes an opening into an interior cavity (not shown) of the breather vent 104, and a clamp 124. The base 112 and cap 116 preferably are comprised of materials that are sufficiently durable and temperature resistant so as to retain their configuration during installation and operation when coupled with the air inlet of the engine. The filter medium 108 circumferentially surrounds the interior cavity such that the filter medium 108 creates an exterior perimeter of at least a portion of the cavity. An exterior cross-sectional shape of the breather vent 104 may be generally circular, oval, or otherwise shaped so as to increase the surface area available for air flow passage for a given volume of the interior cavity. The shape may be consistent along a longitudinal length, or may vary along the longitudinal length. In some embodiments, the outer profile may taper along a longitudinal length of the breather vent 104, from one end to the other end.

The base 112 generally is configured to support the breather vent 104 and provide an interface between the breather vent and the crankcase breather inlet of the engine. The fitting receiver 120 is configured to receive an adaptive fitting 128 which is suitably sized to be received by the crankcase breather inlet of the engine. The clamp 124 is configured to secure the adaptive fitting 128 within the fitting receiver 120 such that air is drawn through the filter medium 108 into the interior cavity of the breather vent 104 and then is conducted through the adaptive fitting 128 into the crankcase breather inlet of the engine.

It will be appreciated that the adaptive fitting 128 has a configuration and a diameter suitable for coupling the breather vent 104 with the crankcase breather inlet of the engine. For example, the adaptive fitting 128 may comprise any of a variety of suitable diameters and lengths, as well as various ridges, raised portions, indentations, lips, or other structural features so as to optimally engage with the crankcase breather inlet of the engine. The specific configuration of the adaptive fitting 128 depends upon the particular make and model of the engine for which the breather vent 104 is to be utilized, and thus the adaptive fitting 128 may be implemented with a wide variety of configurations and diameters, as described herein.

Accordingly, the adaptive fitting 128 comprises a breather end 132 and an inlet end 134. The breather end 132 is configured to be received by the fitting receiver 120, and the inlet end 134 is configured to couple with the crankcase breather inlet of the engine. In some embodiments, the crankcase breather vent package 100 comprises a multiplicity of adaptive fittings 128 so as to accommodate the crankcase breather inlets of one or more different vehicles. In the exemplary embodiment illustrated in FIG. 1, the crankcase breather vent package 100 comprises five differently sized, but similarly configured “male” adaptive fittings 128. The five male adaptive fittings 128 illustrated in FIG. 1 are all configured with substantially identical breather ends 132 so as to be received by the fitting receiver 120 of the breather vent 104. Each of the inlet ends 134, however, comprises a specific outer diameter suitable to couple the breather vent 104 with the crankcase breather inlet of a particular make and model of vehicle. The five adaptive fittings 128 illustrated in FIG. 1 range in outer diameter from substantially ⅜ of an inch to 1.0 inch, including ½, ⅝, or ¾ of an inch, including ranges bordering and including the foregoing values.

FIG. 2 illustrates an exemplary embodiment of a crankcase breather vent package 160 comprising four adaptive fittings 128 configured to couple the breather vent 104 with crankcase breather inlets of various makes and models of vehicles. The four adaptive fittings 128 illustrated in FIG. 2 are substantially similar to the five adaptive fittings shown in FIG. 1, with the exception that the adaptive fittings 128 shown in FIG. 2 each comprises a “female” configuration. Similar to the adaptive fittings of FIG. 1, the four adaptive fittings 128 illustrated in FIG. 2 are all configured with substantially identical breather ends 132, but differently-sized inlet ends 134. Each of the inlet ends 134 comprises an inner diameter sized to receive a specifically-sized flange disposed on the crankcase breather inlet of the engine. The inlet ends 134 of the adaptive fittings 128 illustrated in FIG. 2 are configured to receive flanges ranging in diameter from substantially ⅜ of an inch to 1.0 inch, including ½, ⅝, or ¾ of an inch, including ranges bordering and including the foregoing values.

As best shown in FIG. 1, the base 112 comprises a ridge 136 and a recess 140 configured to receive a lower end 144 of the filter medium 108. It is envisioned that any of a variety of fasteners (not shown) may be used to affix the lower end 144 within the recess 140. In some embodiments, the ridge 136 may be molded to a wire support of the breather vent 104. In some embodiments, the ridge 136 may be crimped such that it folds onto and retains the wire support and the filter medium 108 of the breather vent 104. It will be appreciated by those skilled in the art that affixing the filter medium 108 to the base 112 by way of the ridge 136 and the recess 140 generally renders the filter medium 108 irremovable from the breather vent 104.

It is envisioned that a user of the breather vent 104 may periodically clean the filter medium 108 rather than replacing the breather vent 104, as is typically done with conventional crankcase breather systems. In some embodiments, a method for cleaning the filter medium 108 comprises removing the breather vent 104 from the crankcase breather inlet of the engine, removing the adaptive fitting 128 from the breather vent 104, inserting a water hose through the fitting receiver 120 into the interior cavity of the breather vent 104, and spraying water so as to flush contaminants from the filter medium 108. In some embodiments, the method for cleaning the breather vent 104 may comprise spraying water onto the exterior of the filter medium 108, such that the water and contaminants drain from the exterior of the filter medium 108. Other cleaning methods will be apparent to those skilled in the art without deviating from the spirit and scope of the present disclosure.

As described herein, the lower end 144 of the filter medium 108 is affixed to the base 112 and retained by way of the ridge 140 and the recess 144. The cap 116 may be similarly affixed to the filter medium 108 by way of any of a variety of fasteners (not shown). In some embodiments, the cap 116 may be molded to a wire support of the filter medium 108, as discussed herein. In some embodiments, the cap 116 may be crimped around its peripheral edge such that it folds onto and retains the wire support and the filter medium 108 of the breather vent 104. Any of a variety of fastening means may be practiced for attaching the filter medium 108 and the wire support to the cap 116 without deviating from the spirit and scope of the present disclosure. Further, the cap 116 preferably is comprised of a material which is sufficiently hard so as to retain the filter medium 108 in the desired configuration and support the breather vent 104 when coupled to the crankcase breather inlet of the engine. The filter medium 108 is also preferably durable enough to withstand repeated cleaning and use, as discussed herein.

As described above, the wire support may be incorporated into the filter medium 108 so as to impart additional strength and durability to the breather vent 104, thereby facilitating periodic cleaning and reusing the breather vent 104 instead of discarding the breather vent after each application. In some embodiments, the filter medium 108 may be positioned between the wire support and one or more layers of a reinforcing material. For example, the wire support may comprise wire screens positioned on an outer surface and an inner surface of the filter medium 108. In some embodiments, the wire screens may be comprised of powder-coated aluminum screen wire that is co-pleated along with the filter medium 108 so as to reinforce the breather vent 104. In some embodiments, additional or alternative reinforcements may be provided, as will be apparent to those skilled in the art.

In the embodiment of the breather vent 104 illustrated in FIG. 1, the base 112 has a diameter substantially equal to the diameter of the cap 116. In some embodiments, however, the base 112 may have a larger size than the size of the cap 116. It should be understood that the breather vent 104 of the present disclosure is not limited to the exact shape illustrated in FIG. 1, but rather may include a wide variety of generally cylindrical, circular, oval, round, curved, or other closed perimeter shapes, that provide a relatively large surface area of the filter medium 108. Further, it will be appreciated that the specific configuration of the breather vent 104 depends upon the particular make and model of the engine for which the breather vent 104 is to be utilized, and thus a wide variety of heights and diameters of the filter medium 108 may be incorporated into the breather vent 104 without straying beyond the scope of the present disclosure. Accordingly, in the exemplary embodiments illustrated in FIGS. 1-2, the breather vent 104 has a height of substantially 1.5 inches and a diameter of substantially 2.0 inches.

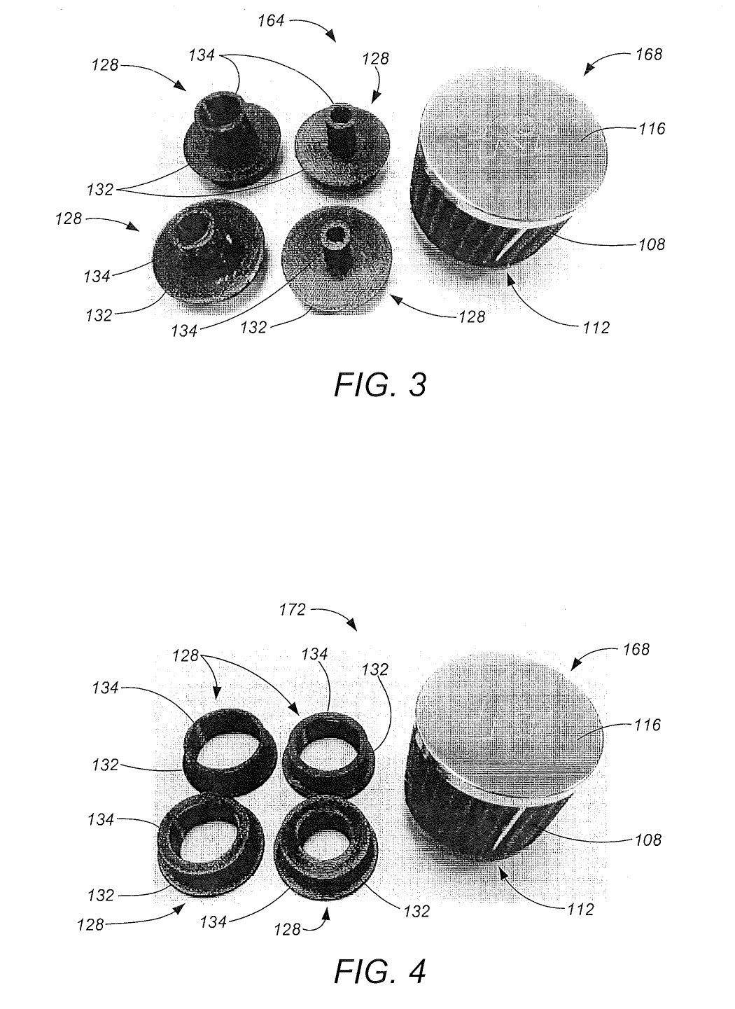

FIG. 3 illustrates an exemplary embodiment of a breather vent package 164 comprising a breather vent 168 and four male adaptive fittings 128 configured to couple the breather vent 168 with different makes and models of vehicles. The breather vent 168 is substantially similar to the breather vent 104 illustrated in FIGS. 1-2, with the exception that the breather vent 168 comprises a diameter of substantially 3.0 inches and a height of substantially 2.5 inches. The adaptive fittings 128 illustrated in FIG. 3 are substantially similar to the adaptive fittings illustrated in FIG. 1, with the exception that the adaptive fittings 128 illustrated in FIG. 3 comprise breather ends 132 sized to be received into the breather vent 168.

FIG. 4 illustrates an exemplary embodiment of a crankcase breather vent package 172 comprising the breather vent 168 bundled with four female adaptive fittings 128. The adaptive fittings 128 illustrated in FIG. 4 are substantially similar to the adaptive fittings 128 illustrated in FIG. 2, with the exception that the adaptive fittings 128 illustrated in FIG. 4 comprise breather ends 132 sized to be received into the breather vent 168. Further, the inlet ends 134 of the adaptive fittings 128 illustrated in FIG. 4 are configured to receive flanges ranging in diameter from substantially 1.0 inch to 1¾ inches, including 1¼, 1⅜, or 1½ of an inch, including ranges bordering and including the foregoing values.

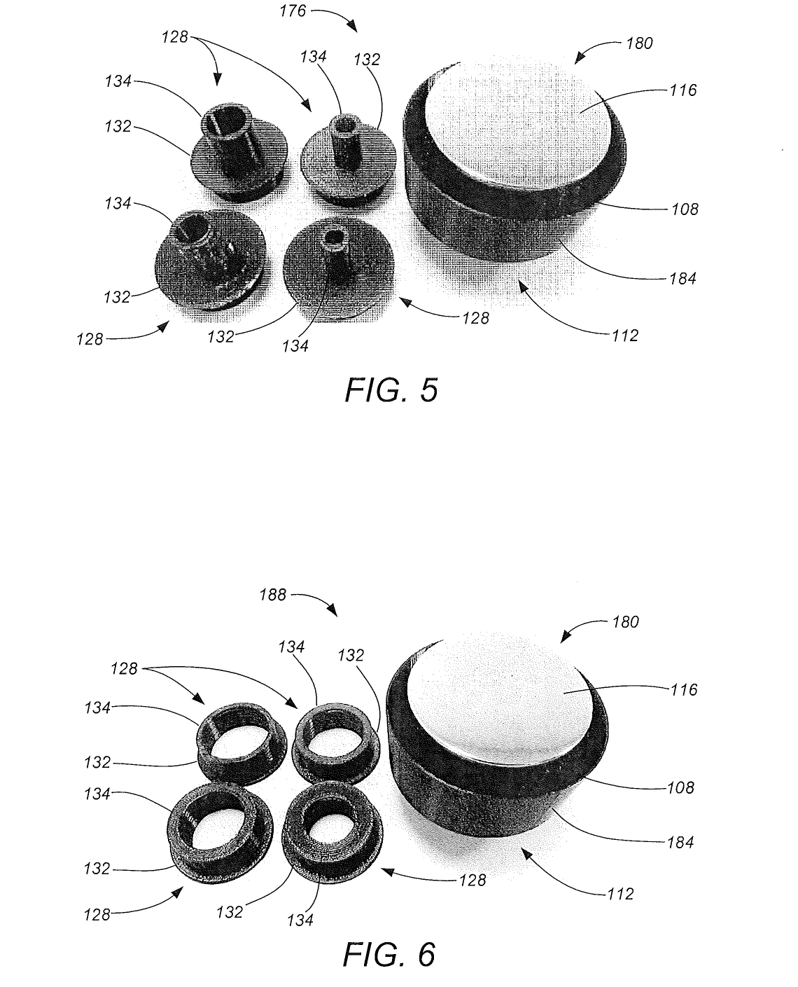

FIG. 5 illustrates an exemplary embodiment of a crankcase breather vent package 176 comprising a breather vent 180 bundled with four male adaptive fittings 128. The breather vent 180 is substantially similar to the breather vent 168 illustrated in FIGS. 3-4, with the exception that the breather vent 180 comprises a protective shield 184 surrounding the filter medium 108. The protective shield 184 is mounted to the base 112 and extends upward adjacent to the filter medium 108. The protective shield 184 is configured with a diameter greater than the filter medium 108 so as to provide an air gap between the protective shield 184 and the filter medium 108. As will be appreciated, the air gap allows unrestricted entry of an airstream into the filter medium 108. Similar to the embodiments illustrated in FIGS. 2-4, the four male adaptive fittings 128 illustrated in FIG. 5 comprise inlet ends 134 suitably sized to couple the breather vent 180 with different makes and models of vehicles. The inlet ends 134 of the adaptive fittings 128 illustrated in FIG. 5 are configured with diameters ranging from substantially ⅜ of an inch to 1.0 inch, including ½, ⅝, or ¾ of an inch, including ranges bordering and including the foregoing values.

FIG. 6 illustrates an exemplary embodiment of a crankcase breather vent package 188 comprising the breather vent 180 and four female adaptive fittings 128. The adaptive fittings 128 illustrated in FIG. 6 are substantially similar to the adaptive fittings 128 illustrated in FIG. 4, with the exception that the adaptive fittings 128 illustrated in FIG. 6 comprise breather ends 132 sized to be received into the breather vent 180. Similar to the inlet ends 134 of the fittings shown in FIG. 4, the inlet ends 134 of the female adaptive fittings 128 of FIG. 6 are configured to receive flanges ranging in diameter from substantially 1.0 inch to 1¾ inches, including 1¼, 1⅜, or 1½ of an inch, including ranges bordering and including the foregoing values.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A breather vent configured to be mounted onto a crankcase breather inlet of an internal combustion engine, comprising:
a base comprising a fitting receiver configured to retain an adaptive fitting which is suitably sized to be received by the crankcase breather inlet and includes an opening into an interior cavity of the breather vent;
a clamp configured to secure the adaptive fitting within the fitting receiver;
a filter medium fastened to the base and configured to remove particulate matter and other contaminates from an incoming airstream, the filter medium circumferentially surrounding the interior cavity so as to form an exterior perimeter of at least a portion of the cavity; and
a cap affixed to the filter medium, such that the filter medium is retained between the base and the cap.

2. The breather vent of claim 1, wherein the base and the cap are configured such that the incoming airstream is drawn through the filter medium into the interior cavity and then is conducted through the adaptive fitting into the crankcase breather inlet of the engine.

3. The breather vent of claim 1, wherein the filter medium is comprised of paper, foam, cotton, spun fiberglass, or other known filter materials, woven or non-woven material, synthetic or natural, or any combination thereof.

4. The breather vent of claim 1, wherein the filter medium is pleated or otherwise shaped or contoured to increase a surface area for passing the airstream to be cleaned.

5. The breather vent of claim 1, wherein the filter medium comprises a filter oil composition to enhance air cleaning properties of the filter medium.

6. The breather vent of claim 1, wherein a wire support is incorporated into the filter medium so as to impart additional strength and durability to the breather vent.

7. The breather vent of claim 6, wherein the filter medium is positioned between the wire support and one or more layers of a reinforcing material.

8. The breather vent of claim 6, wherein the wire support comprises wire screens positioned on an outer surface and an inner surface of the filter medium.

9. The breather vent of claim 8, wherein the wire screens are comprised of powder-coated aluminum screen wire that is co-pleated along with the filter medium so as to reinforce the breather vent.

10. The breather vent of claim 1, wherein the adaptive fitting comprises a breather end and an inlet end, the breather end being configured to be retained by the fitting receiver, and the inlet end being configured to be coupled with the crankcase breather inlet of the engine.

11. The breather vent of claim 1, wherein the adaptive fitting comprises an inlet end having a configuration and a diameter suitable for coupling the breather vent with the crankcase breather inlet of the engine.

12. The breather vent of claim 11, wherein the inlet end comprises a male configuration having an outer diameter suitable to couple the breather vent with the crankcase breather inlet of the engine.

13. The breather vent of claim 11, wherein the inlet end comprises a female configuration having an inner diameter suitable to couple the breather vent with the crankcase breather inlet of the engine.

14. A method for a breather vent to be mounted onto a crankcase breather inlet of an internal combustion engine, comprising:
forming an adaptive fitting comprising an opening and having a breather end and an inlet end, such that the inlet end is suitably sized to be coupled with the crankcase breather inlet of the engine;
configuring a fitting receiver within a base to retain the breather end, such that the opening provides fluid communication between the crankcase breather inlet of the engine and an interior cavity of the breather vent;
securing the adaptive fitting within the fitting receiver by way of a clamp;
fabricating a filter medium to remove particulate matter and other contaminates from an airstream flowing there through;
fastening the filter medium to the base, the filter medium being disposed circumferentially around the interior cavity so as to form an exterior perimeter of at least a portion of the interior cavity; and
affixing a cap to the filter medium, such that the filter medium is retained between the base and the cap.

15. The method of claim 14, wherein forming the adaptive fitting comprises configuring the inlet end with a diameter suitable for coupling the breather vent with the crankcase breather inlet of the engine.

16. The method of claim 15, wherein configuring the inlet end comprises forming a male configuration of the inlet end having an outer diameter suitable to be received by the crankcase breather inlet of the engine.

17. The method of claim 15, wherein configuring the inlet end comprises forming a female configuration of the inlet end having an inner diameter suitable to receive the crankcase breather inlet of the engine.

18. The method of claim 14, wherein fabricating the filter medium comprises forming any of paper, foam, cotton, spun fiberglass, or other known filter materials, woven or non-woven material, synthetic or natural, or any combination thereof, into a surface area for passing an airstream to be cleaned.

19. The method of claim 18, wherein fabricating the filter medium comprises incorporating a wire support into the filter medium so as to impart additional strength and durability to the breather vent.

20. The method of claim 19, wherein incorporating the wire support comprises positioning a first wire screen on an outside surface of the filter medium and positioning a second wire screen on an inner surface of the filter medium.
